(19) United States
(12) Patent Application Publication
(10) Pub. No.: US 2019/0326756 A1
(43) Pub. Date: Oct. 24, 2019

(54) MICROGRID GATEWAY AND CONTROL METHOD THEREOF

(71) Applicant: NexChal Co., Ltd., Gyeonggi-do (KR)

(72) Inventors: Jungwon CHO, Daejeon (KR); Kyu Won LEE, Sejong-si (KR); Ssang Seok OH, Seoul (KR); Hak JANG, Gyeonggi-do (US)

(21) Appl. No.: 15/956,577

(22) Filed: Apr. 18, 2018

(51) Int. Cl. H02J 3/38; G06F 11/30; G05B 19/042; H04L 29/08

(52) U.S. Cl. CPC H02J 3/382; G06F 11/3089; G05B 2219/2639; H04L 67/1093; G05B 19/0423

(57) ABSTRACT

Disclosed are a microgrid gateway and a control method thereof. That is, according to the embodiment of the present invention, after various data is temporarily stored in the specific system module, when the input is completed, the abnormality of the corresponding specific system module is determined by the reset module in the process of storing the various data temporarily stored in the database, thereby reducing a database access load and securing gateway hardware performance hard to an operating environment.

### BACKGROUND OF THE INVENTION

### Field of the Invention

The present invention relates to a microgrid gateway and a control method thereof and more particularly, to a microgrid gateway and a control method thereof which determines abnormality of a specific system module by a reset module in a process of storing various data temporarily stored in a database when an input is completed after various data is temporarily stored in the specific system module.

### Description of the Related Art

A fail safe design is a technique that is necessarily provided in equipment of an electric power field which is the national basic industry as a technique used in an industry field in which a fatal accident occurs when there is a problem in facilities such as railways, aircraft, spacecraft, nuclear power plants, and the like.

Particularly, in a network-based system connected to existing power facilities through various sensors such as supervisory control and data acquisition (SCADA), since power is effectively managed by performing a system control using a variety of information received from a power system, a normal operation of a gateway which collects a sensing signal and connects the collected sensing signal to an upper system such as an energy management system is required as a very important function.

In addition, in a microgrid field for renewable energy, since natural energy such as wind power, solar power, and tidal power is converted to electric power energy, most places where the facilities are installed are poor in an operating environment such as temperature, humidity, and dust.

As such, in the case of a microgrid gateway, when various data is collected, the collected data is stored in the database in real time, and thus, there is a problem in that a load on the corresponding database is increased.

### SUMMARY OF THE INVENTION

The present invention has been made in an effort to provide a microgrid gateway and a control method thereof which determines abnormality of a specific system module by a reset module in a process of storing various data temporarily stored in a database when an input is completed after various data is temporarily stored in the specific system module.

Further, the present invention has been made in an effort to provide a microgrid gateway and a control method thereof which feature-vectorizes an electrical signal generated by a specific system module, and determine whether the corresponding specific system module is in the normal operation state by comparing the feature vector and a normal pattern or determine whether the abnormality of the corresponding specific system module is present through whether the signal for confirming the abnormal state at a predetermined interval is transmitted from the corresponding specific system module.

An embodiment of the present invention provides a control method of a microgrid gateway including steps of: temporarily storing, by a system module, data collected in a lower region of a root node in a memory in real time and converting a state of the root node to a state in which predetermined information is being input; converting, by the system module, the state of the root node from the state in which the information is being input to a state indicating information input completion when the data collection is completed; retrieving, by the system module, a root node of which the state is in the information input completion state from one or more root nodes in the memory; and storing, by the system module, the data temporarily stored in the lower region of the retrieved root node in the database when the root node, of which the state is in the information input completion state, is retrieved from one or more root nodes in the memory as the retrieving result and converting the state of the retrieved root node from the state indicating the information input completion to a database processing completion state.

As one example associated with the present invention, the control method may further include steps of: transmitting, by the system module, an abnormal state verification request signal to a reset module to confirm whether the abnormal state is present at a predetermined time interval while the data is temporarily stored; transmitting, by the reset module, a response signal to the abnormal state verification request signal transmitted from the system module to the system module; and receiving, by the system module, the response signal transmitted from the reset module in response to the transmitted abnormal state verification request signal.

As one example associated with the present invention, the control method may further include steps of: collecting, by the reset module, an electrical signal generated by the system module; converting, by the reset module, the collected electrical signal to a feature vector; determining, by the reset module, the abnormality of the system module; and confirming, by the reset module, that the system module is operating in an abnormal state when it is determined that there is the abnormality in the system module as the determining result and resetting the whole system including the reset module.

As one example associated with the present invention, in the determining of the abnormality of the system module, the reset module may determine whether the system module is in a normal operation state by comparing the feature vector with a normal pattern associated with the corresponding system module.

As one example associated with the present invention, in the determining of the abnormality of the system module, the reset module may determine whether or not to receive the abnormal state verification request signal transmitted from the system module at the predetermined time interval.

As one example associated with the present invention, the control method may further include steps of: transmitting, by the system module, the abnormal state verification request signal to the reset module, when the root node of which the state is in the information input completion state is not retrieved from one or more root nodes in the memory as the retrieving result; and verifying, by the reset module, the abnormality of the system module based on the abnormal state verification request signal.

Another embodiment of the present invention provides a microgrid gateway including: a memory including a plurality of root nodes; a database; and a system module which temporarily stores data collected in a lower region of a root node selected from the plurality of root nodes in real time, converts the state of the root node to a state in which predetermined information is being input, converts the state of the root node from the state in which the information is being input to a state indicating information input completion when the data collection is completed, stores the data temporarily stored in the lower region of the retrieved root node in the database when the root node of which the state is in the information input completion state is retrieved from one or more root nodes in the memory, and converts the state of the retrieved root node from the state indicating the information input completion to a database processing completion state.

As one example associated with the present invention, the microgrid gateway may further include a reset module which receives an abnormal state verification request signal to confirm whether the abnormal state transmitted from the system module is present at a predetermined time interval while the data is temporarily stored and transmits a response signal to the received abnormal state verification request signal to the system module.

As one example associated with the present invention, the reset module may collect an electrical signal generated by the system module, convert the collected electrical signal to a feature vector, determine the abnormality of the system module, confirm that the system module is operating in an abnormal state when it is determined that there is the abnormality in the system module as the determining result, and reset the whole system including the reset module.

According to the present invention, after various data is temporarily stored in the specific system module, when the input is completed, the abnormality of the corresponding specific system module is determined by the reset module in the process of storing the various data temporarily stored in the database, thereby reducing a database access load and securing gateway hardware performance hard to an operating environment.

Further, according to the present invention, the reset module feature-vectorizes the electrical signal generated by the specific system module, and determines whether the corresponding specific system module is in the normal operating state by comparing the feature vector with the normal pattern or determines the abnormality of the corresponding specific system module through whether the signal for confirming the abnormal state from the corresponding specific system module is transmitted at a predetermined time interval, thereby improving operating efficiency of the whole system by determining a normal operating state and an abnormal operating state through operation state monitoring according to a statistical model.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a configuration of a microgrid gateway according to an embodiment of the present invention; and

FIGS. 2 and 3 are flowcharts illustrating a control method of a microgrid gateway according to another embodiment of the present invention.

### DETAILED DESCRIPTION OF THE PREFERRED EMBODIMENT

Technical terms used in the present invention are used only to describe specific embodiments, and are not intended to limit the present invention. Further, unless otherwise defined, the technical terms used in the present invention should be interpreted as meanings generally appreciated by those skilled in the art and should not be interpreted as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art.

In addition, a general term used in the present invention should be interpreted as defined in a dictionary or contextually, and should not be interpreted as an excessively reduced meaning.

Further, singular expressions used in the present invention include plural expressions unless they have definitely opposite meanings in the context. In the present invention, a term such as “comprising” or “including” should not be interpreted as necessarily including all various components or various steps disclosed in the invention, and it should be interpreted that some component or some steps among them may not be included or additional components or steps may be further included.

Further, terms including an ordinary number, such as first and second, and the like are used for describing various components, but the components are not limited by the terms. The above terms are used only to discriminate one component from the other components. For example, a first component may be 0.10 referred to as a second component, and similarly, the second component may be referred to as the first component without departing from the scope of the present invention.

Hereinafter, embodiments of the present invention will be described in detail with reference to the accompanying drawings, in which like reference numerals refer to like or similar elements regardless of reference numerals and a duplicated description thereof will be omitted.

Further, in the following description, a detailed explanation of known associated technologies may be omitted to avoid unnecessarily obscuring the subject matter of the present disclosure. Further, it is noted that the accompanying drawings are only for easily understanding the spirit of the present invention and it should not be interpreted that the spirit of the present invention is limited by the accompanying drawings.

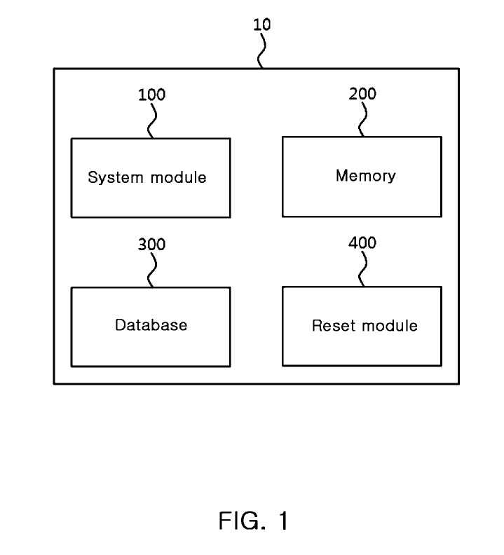

FIG. 1 is a block diagram illustrating a configuration of a microgrid gateway 10 according to an embodiment of the present invention.

As illustrated in FIG. 1, the microgrid gateway 10 is constituted by a system module 100, a memory 200, a database 300, and a reset module 400. All the components of the microgrid gateway 10 illustrated in FIG. 1 are not essential components, and the microgrid gateway 10 may be implemented by more components than the components illustrated in FIG. 1 or may also be implemented by less components therethan.

The system module 100 collects data such as power generation equipment, measurement data, and the like in real time based on the IEC61970 (CIM: Common Information Model) standard. In this case, the data may be supervisory control and data acquisition (SCADA) data and includes equipment data, measurement data, history data, and the like.

In the embodiment of the present invention, the CIM gateway data collection is mainly described, but the present invention is not limited thereto, and the system module 100 may also collect SG gateway data including weather station data, iSmart data, and the like.

In addition, the system module 100 temporarily stores the collected data in a lower region of any one root node of a plurality of root nodes in the memory 200. In this case, the system module 100 converts a state of the root node to a state in which predetermined information is being input (for example, set a specific bit of the corresponding root node to ‘1’).

In addition, the system module 100 transmits an abnormal state verification request signal to the reset module 400 to confirm whether the abnormal state is present at a predetermined time interval (alternatively, a preset cycle).

In addition, the system module 100 receives a response signal transmitted from the reset module 400 in response to the abnormal state verification request signal transmitted above.

In addition, the system module 100 collects the data and continuously performs a process of temporarily storing the collected data in the lower region of the root node in the memory 200.

In addition, when there is an error in the whole system and/or the system module 100, the system module 100 may also not receive the response signal transmitted from the reset module 400 in response to the abnormal state verification request signal transmitted above.

In addition, when data collection is completed in the system module 100, the system module 100 converts the state of the corresponding root node in the memory 200 which temporarily stores the collected data from the state in which the information is being input to a state indicating the predetermined information input completion (for example, converts/sets a specific bit of the corresponding root node from ‘1’ to ‘0’).

In addition, the system module 100 retrieves a root node of which the state is in the information input completion state from one or more root nodes in the memory 200.

As the retrieving result, when the root node of which the state is in the information input completion state is not retrieved from one or more root nodes in the memory 200, the system module 100 transmits the abnormal state verification request signal to the reset module 400 to confirm whether the abnormal state of the corresponding system module 100 is present.

In addition, as the retrieving result, when the root node of which the state is in the information input completion state is retrieved from one or more root nodes in the memory 200, the system module 100 stores in the database 300 the data (for example, including equipment data, measurement data, history data, and the like) which are temporarily stored in the lower region of the retrieved root node in the corresponding memory 200 based on mapping rules and the like of the database 300.

After the data temporarily stored in the lower region of the root node are stored in the database 300, the system module 100 converts the state of the corresponding root node from the state indicating the information input completion to a pre-set database processing completion state (for example, converts/sets another specific bit of the corresponding root node to ‘1’).

The memory (alternatively, a storage unit) 200 temporarily stores the data collected by the system module 100.

In this case, the memory 200 may be divided into (alternatively, classified into) a plurality of regions, a root node is set in each region, and the data collected by the system module 100 may be temporarily stored in the lower region of the root node. Herein, the state of the root node may indicate the state in which the information is being input, the state indicating the information input completion, the database processing completion state, and the like through at least one bit.

The database 300 stores the data collected by the system module 100. In this case, when the data collected by the system module 100 in real time is stored in the database 300 in real time, the load of the database 300 increases, and thus, in the embodiment of the present invention, the data collected by the system module 100 in real time is temporarily stored in the memory 200. Thereafter, when the real-time data collection is completed, the system module 100 is constituted to store the data temporarily stored in the memory 200 in the database 300, thereby reducing a load of the database 300.

The reset module 400 performs the overall control function of the microgrid gateway 10.

Also, the reset module 400 receives the abnormal state verification request signal transmitted from the system module 100.

In addition, the reset module 400 transmits a response signal to the received abnormal state verification request signal to the system module 100. Here, the response signal includes a signal indicating a normal state, a signal indicating that there is an error in the corresponding system module 100/another system module, and the like.

In addition, the reset module 400 collects an electrical signal generated by the system module 100.

In addition, the reset module 400 feature-vectorizes the electrical signal generated by the system module 100.

In addition, the reset module 400 converts the electrical signal generated by the system module 100 to a feature vector.

Also, the reset module 400 determines (alternatively, confirms) abnormality of the system module 100.

At this time, the reset module 400 determines whether the corresponding system module 100 is in a normal operation state by comparing the feature-vectorized feature vector with a normal pattern (alternatively, a reference pattern) associated with the corresponding system module 100.

That is, the reset module 400 applies an analysis of variance to the feature vector to determine whether the corresponding system module 100 associated with the feature vector is in a normal operation state. At this time, logic for determining whether the system module 100 is in the normal operation state applies a variance value of an abnormal pattern based on a statistical average value. Herein, the variance value may be set to a threshold value determined by an experiment result reflecting various situations, and is used for measuring a distance for an average, and indicates a degree of distortion with respect to the normal pattern.

In addition, the reset module 400 determines whether or not to receive the abnormal state verification request signal transmitted from the system module 100 at a predetermined time interval.

As the determining result, when it is determined that there is no abnormality in the system module 100 (alternatively, the system module 100 is in the normal state), the reset module 400 confirms that the corresponding system module 100 is operating (alternatively, executing) in the normal state and returns to the process of collecting the electrical signal generated by the corresponding system module 100.

That is, as the comparing result, when the feature vector coincides with the normal pattern associated with the corresponding system module 100 (alternatively, the feature vector is present within a predetermined error range of the normal pattern associated with the system module 100), the reset module 400 confirms that the corresponding system module 100 is operating (alternatively, executing) in the normal state and returns to the process of collecting the electrical signal generated in the corresponding system module 100.

In addition, as the determining result, when the reset module 400 receives the abnormal state verification request signal transmitted from the system module 100 at the predetermined time interval, the reset module 400 confirms that corresponding system module 100 is operating in a normal state, and returns to the process of collecting the electrical signal generated in the corresponding system module 100.

Also, as the determining result, when it is determined that there is abnormality in the system module 100 (alternatively, when the system module 100 is in the abnormal state), the reset module 400 resets (alternatively, initializes) the whole system (not illustrated) including the corresponding microgrid gateway 10.

That is, as the comparing result, when the feature vector does not coincide with the normal pattern associated with the corresponding system module 100 (alternatively, the feature vector is not present within a predetermined error range of the normal pattern associated with the system module 100/is beyond the error range), the reset module 400 confirms that the corresponding system module 100 is operating (or executing) in the abnormal state and resets (alternatively, initializes) the whole system including the corresponding microgrid gateway 10.

In addition, as the determining result, when the reset module 400 does not receive the abnormal state verification request signal transmitted from the system module 100 at the predetermined time interval, the reset module 400 confirms that the corresponding system module 100 is operating (or executing) in the abnormal state and resets (alternatively, initializes) the whole system.

The reset module 400 may store log information on abnormal state verification, log information on situations causing the reset (for example, including output voltage abnormality of switching mode power supply (SMPS), power failure, etc.), and the like.

When the root node of which the state is in the information input completion state is not retrieved from one or more root nodes in the memory 200, if the reset module 400 receives the abnormal state verification request signal transmitted from the system module 100, the reset module 400 transmits a response signal to the abnormal state verification request signal to the system module 100 and performs a process of determining (alternatively, verifying) whether the abnormality of the system module 100 is present.

In the embodiment of the present invention, through the processes, in the system module 100, according to the result of retrieving the root node of which the state is in the information input completion state from one or more root nodes in the memory 200, it is described that the reset module 400 verifies whether the abnormality of the corresponding system module 100 is present or stores the temporarily stored data in the database 300. However, the present invention is not limited thereto, and while the retrieving process is omitted, when the data collection in the system module 100 is completed (alternatively, when the state of the specific root node in the memory 200 is converted from the state in which the information is being input to the state indicating the information input completion), the system module 100 may also store the data temporarily stored in the lower region of the corresponding root node (for example, including equipment data, measurement data, history data, and the like) in the database 300 based on mapping rules and the like of the database 300.

As such, after the various data is temporarily stored in the specific system module, when the input is completed, the reset module may determine the abnormality of the corresponding specific system module in the process of storing the various data temporarily stored in the database.

Further, as such, the reset module may feature-vectorize the electrical signal generated in the specific system module, and determine whether the corresponding specific system module is in the normal operation state by comparing the feature vector and the normal pattern or determine whether the abnormality of the corresponding specific system module is present through whether the signal for confirming the abnormal state is transmitted from the corresponding specific system module at a predetermined time interval.

Hereinafter, a control method of the microgrid gateway according to the present invention will be described in detail with reference to FIGS. 1 to 3.

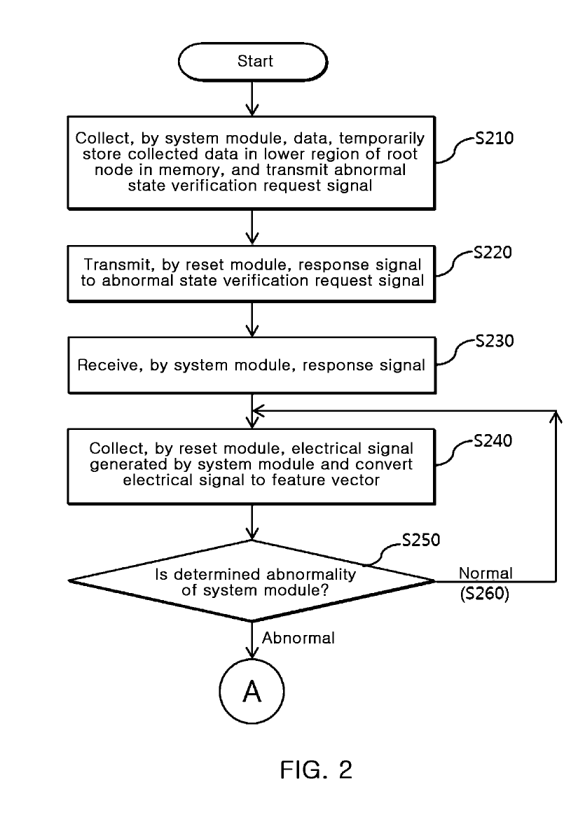

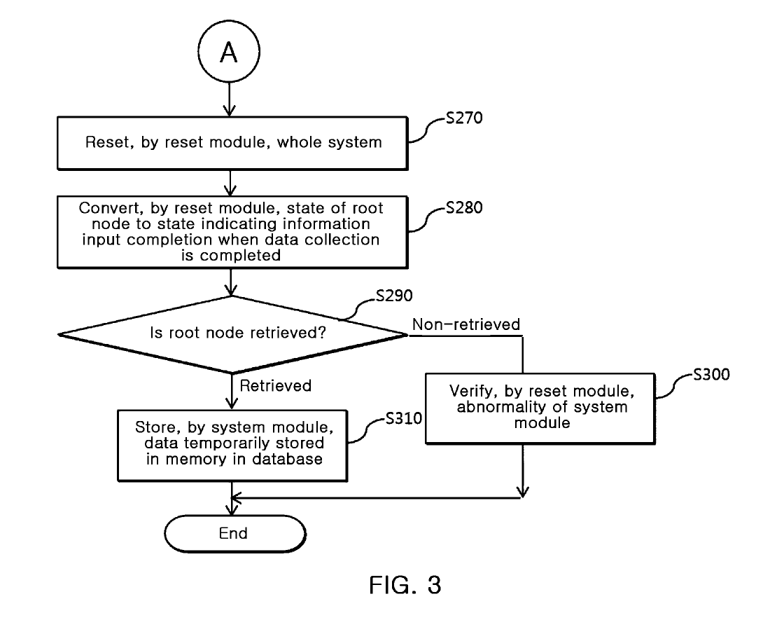

FIGS. 2 and 3 are flowcharts illustrating a control method of the microgrid gateway according to another embodiment of the present invention.

First, the system module 100 collects data such as power generation equipment, measurement data, and the like based on the IEC61970 (CIM: Common Information Model) standard. At this time, the data may be supervisory control and data acquisition (SCADA) data and includes equipment data, measurement data, history data, and the like.

In addition, the system module 100 temporarily stores the collected data in a lower region of any one root node of a plurality of root nodes in the memory 200. In this case, the system module 100 converts a state of the root node to a state in which predetermined information is being input (for example, set a specific bit of the corresponding root node to ‘1’).

In addition, the system module 100 transmits an abnormal state verification request signal to the reset module 400 to confirm whether the abnormal state is present at a predetermined time interval (alternatively, a preset cycle).

As an example, a first system module 100 sets a specific bit in a first root node selected from the plurality of root nodes in the memory 200 to ‘1’ and temporarily stores a plurality of equipment data, a plurality of measurement data, a plurality of history data, and the like which are sequentially collected, in a lower region in the first root node.

In addition, the first system module transmits to a first reset module 400 a first abnormal state verification request signal for confirming the abnormality of the first system module at a predetermined period (S210).

Thereafter, the reset module 400 receives the abnormal state verification request signal transmitted from the system module 100.

In addition, the reset module 400 transmits a response signal to the received abnormal state verification request signal to the system module 100. Herein, the response signal includes a signal indicating a normal state, a signal indicating that there is an error in the corresponding system module 100/another system module, and the like.

As an example, the first reset module receives a first abnormal state verification request signal transmitted from the first system module and transmits to the first system module a first response signal including information indicating that the whole system (not illustrated) including the corresponding microgrid gateway 10 is normally operating in response to the received first abnormal state verification request signal (S220).

Thereafter, the system module 100 receives a response signal transmitted from the reset module 400 in response to the abnormal state verification request signal transmitted above.

In addition, the system module 100 collects the data and continuously performs a process of temporarily storing the collected data in the lower region of the root node in the memory 200.

As an example, the first system module receives the first response signal transmitted from the first reset module in response to the first abnormal state verification request signal transmitted above.

In addition, the first system module continuously performs a process of temporarily storing the plurality of equipment data, the plurality of measurement data, the plurality of history data, and the like which are sequentially collected, in the lower region in the first root node (S230).

Thereafter, the reset module 400 collects an electrical signal generated by the system module 100.

In addition, the reset module 400 feature-vectorizes the electrical signal generated by the system module 100.

That is, the reset module 400 converts the electrical signal generated by the system module 100 to a feature vector.

As an example, the first reset module collects a first electrical signal generated by the first system module and converts (alternatively, feature-vectorizes) the collected first electrical signal to a first feature vector (S240).

Thereafter, the reset module 400 determines (alternatively, confirms) abnormality of the system module 100.

At this time, the reset module 400 determines whether the corresponding system module 100 is in a normal operation state by comparing the feature-vectorized feature vector with a normal pattern (alternatively, a reference pattern) associated with the corresponding system module 100.

That is, the reset module 400 applies an analysis of variance to the feature vector to determine whether the corresponding system module 100 associated with the feature vector is in a normal operation state. At this time, logic for determining whether the system module 100 is in the normal operation state applies a variance value of an abnormal pattern based on a statistical average value. Herein, the variance value may be set to a threshold value determined by an experimental result reflecting various situations.

In addition, the reset module 400 determines whether or not to receive the abnormal state verification request signal transmitted from the system module 100 at the predetermined time interval.

As an example, the first reset module compares a normal pattern associated with the first system module pre-stored in the first reset module with the first feature vector.

As another example, the first reset module determines whether or not to receive the abnormal state verification request signal transmitted from the first system module at the predetermined cycle (S250).

As the determining result, when it is determined that there is no abnormality in the system module 100 (alternatively, the system module 100 is in the normal state), the reset module 400 confirms that the corresponding system module 100 is operating (alternatively, executing) in the normal state and returns to the process of collecting the electrical signal generated by the corresponding system module 100.

That is, as the comparing result, when the feature vector coincides with the normal pattern associated with the corresponding system module 100 (alternatively, the feature vector is present within a predetermined error range of the normal pattern associated with the system module 100), the reset module 400 confirms that the corresponding system module 100 is operating (or executing) in the normal state and returns to the process of collecting the electrical signal generated in the corresponding system module 100.

In addition, as the determining result, when the reset module 400 receives the abnormal state verification request signal transmitted from the system module 100 at the predetermined time interval, the reset module 400 confirms that corresponding system module 100 is operating in the normal state and returns to the process of collecting the electrical signal generated by the corresponding system module 100.

As an example, when the normal pattern associated with the first system module coincides with the first feature vector, the first reset module performs the process (for example, step S240) of collecting the electrical signal associated with the first system module.

As another example, when the first reset module receives the abnormal state verification request signal transmitted from the first system module at the predetermined cycle, the first reset module performs the process (for example, step S240) of collecting the electrical signal associated with the first system module (S260).

Further, as the determining result, when it is determined that there is abnormality in the system module 100 (alternatively, when the system module 100 is in the abnormal state), the reset module 400 resets (alternatively, initializes) the whole system (not illustrated) including the corresponding microgrid gateway 10.

That is, as the comparing result, when the feature vector does not coincide with the normal pattern associated with the corresponding system module 100 (alternatively, the feature vector is not present within a predetermined error range of the normal pattern associated with the system module 100/is beyond the error range), the reset module 400 confirms that the corresponding system module 100 is operating (alternatively, executing) in an abnormal state and resets (alternatively, initializes) the whole system including the corresponding microgrid gateway 10.

In addition, as the determining result, when the reset module 400 does not receive the abnormal state verification request signal transmitted from the system module 100 at the predetermined time interval, the reset module 400 confirms that the corresponding system module 100 is operating (or executing) in the abnormal state and resets (alternatively, initializes) the whole system.

In addition, the reset module 400 may store log information on abnormal state verification, log information on situations causing the reset (for example, including output voltage abnormality of switching mode power supply (SMPS), power failure, etc.), and the like.

As an example, when the normal pattern associated with the first system module does not coincide with the first feature vector, the first reset module determines that the first system module is abnormally operating to control the whole system including the first reset module to be reset.

As another example, when the first reset module does not receive the abnormal state verification request signal transmitted from the first system module at the predetermined cycle, the first reset module determines that the first system module is abnormally operating to control the whole system including the first reset module to be reset (S270).

Thereafter, when data collection is completed in the system module 100, the system module 100 converts the state of the corresponding root node in the memory 200 which temporarily stores the collected data from the state in which the information is being input to a state indicating the predetermined information input completion (for example, converts/sets a specific bit of the corresponding root node from ‘1’ to ‘0’).

As an example, when the data collection is completed in the first system module, the first system module converts (alternatively, changes) a specific bit in the first root node from ‘1’ to ‘0’ (S280).

Thereafter, the system module 100 retrieves a root node of which the state is in the information input completion state from one or more root nodes in the memory 200.

As an example, the first system module retrieves a root node of which a specific bit is ‘0’ indicating the information input completion, from the plurality of root nodes in the memory 200 (S290).

As the retrieving result, when the root node of which the state is in the information input completion state is not retrieved from one or more root nodes in the memory 200, the system module 100 transmits the abnormal state verification request signal to the reset module 400 to confirm whether the abnormal state of the corresponding system module 100 is present.

In addition, the reset module 400 transmits to the system module 100 a response signal to the abnormal state verification request signal transmitted from the system module 100 and performs the process of determining (alternatively, verifying) the abnormality of the system module 100.

As an example, as the retrieving result, when the root node of which the specific bit is ‘0’ indicating the information input completion is not retrieved from the plurality of root nodes in the memory 200, the first system module transmits a second abnormal state verification request signal to the first reset module to confirm the abnormality of the first system module. In addition, after the first reset module receives the second abnormal state verification request signal, the first reset module performs the process (for example, steps S250 to S270) of determining the abnormality of the first system module (S300).

In addition, as the retrieving result, when the root node of which the state is in the information input completion state is retrieved from one or more root nodes in the memory 200, the system module 100 stores in the database 300 the data (for example, including equipment data, measurement data, history data, and the like) which are temporarily stored in the lower region of the retrieved root node in the corresponding memory 200 based on mapping rules and the like of the database 300.

After the data temporarily stored in the lower region of the root node is stored in the database 300, the system module 100 converts the state of the corresponding root node from the state indicating the information input completion to a database processing completion state (for example, converts/sets another specific bit of the corresponding root node to ‘1’).

As an example, as the retrieving result, when a first root node of which the specific bit is ‘0’ indicating the information input completion is retrieved from the plurality of root nodes in the memory 200, the first system module stores the data temporarily stored in the lower region of the first root node in the database 300 (S310).

According to the embodiment of the present invention, as described above, after various data is temporarily stored in the specific system module, when the input is completed, the reset module determines the abnormality of the corresponding specific system module in the process of storing the various data temporarily stored in the database, thereby reducing a database access load and securing gateway hardware performance hard to an operating environment.

Further, according to the embodiment of the present invention, as described above, the reset module feature-vectorizes the electrical signal generated by the specific system module, and determines whether the corresponding specific system module is in the normal operating state by comparing the feature vector with the normal pattern or determines the abnormality of the corresponding specific system module through whether the signal for confirming the abnormal state from the corresponding specific system module at a predetermined time interval is transmitted, thereby improving operating efficiency of the whole system by determining a normal operating state and an abnormal operating state through operation state monitoring according to a statistical model.

The present invention can be widely used in a failure safety design field, a renewable energy management field, a microgrid gateway field, a data management field, and the like, by determining the abnormality of the corresponding specific system module by the reset module in the process of storing the various data temporarily stored in the database when the input is completed after the various data is temporarily stored in the specific system module to reduce a database access load and secure gateway hardware performance hard to an operating environment.

The aforementioned contents can be corrected and modified by those skilled in the art without departing from the essential characteristics of the present invention. Accordingly, the embodiments disclosed in the present invention are not intended to limit the technical spirit but describe the technical spirit, and the scope of the technical spirit of the present invention is not limited to the embodiments. The protective scope of the present invention should be construed based on the following claims, and all the technical concepts in the equivalent scope thereof should be construed as falling within the scope of the present invention.

What is claimed is:

1. A control method of a microgrid gateway comprising steps of:
temporarily storing, by a system module, data collected in a lower region of a root node in a memory in real time and converting a state of the root node to a state in which predetermined information is being input;
converting, by the system module, the state of the root node from the state in which the information is being input to a state indicating information input completion when the data collection is completed;
retrieving, by the system module, a root node of which the state is in the information input completion state from one or more root nodes in the memory; and
storing, by the system module, the data temporarily stored in the lower region of the retrieved root node in the database when the root node, of which the state is in the information input completion state, is retrieved from one or more root nodes in the memory as the retrieving result and converting the state of the retrieved root node from the state indicating the information input completion to a database processing completion state.

2. The control method of claim 1, further comprising steps of:
transmitting, by the system module, an abnormal state verification request signal to a reset module to confirm whether the abnormal state is present at a predetermined time interval while the data is temporarily stored;
transmitting, by the reset module, a response signal to the abnormal state verification request signal transmitted from the system module to the system module; and
receiving, by the system module, the response signal transmitted from the reset module in response to the transmitted abnormal state verification request signal.

3. The control method of claim 2, further comprising steps of:
collecting, by the reset module, an electrical signal generated by the system module;
converting, by the reset module, the collected electrical signal to a feature vector;
determining, by the reset module, the abnormality of the system module; and
confirming, by the reset module, that the system module is operating in an abnormal state when it is determined that there is the abnormality in the system module as the determining result and resetting the whole system including the reset module.

4. The control method of claim 3, wherein in the determining of the abnormality of the system module, the reset module determines whether the system module is in a normal operation state by comparing the feature vector with a normal pattern associated with the corresponding system module.

5. The control method of claim 3, wherein in the determining of the abnormality of the system module, the reset module determines whether or not to receive the abnormal state verification request signal transmitted from the system module at the predetermined time interval.

6. The control method of claim 1, further comprising steps of:
transmitting, by the system module, the abnormal state verification request signal to the reset module, when the root node of which the state is in the information input completion state is not retrieved from one or more root nodes in the memory as the retrieving result; and
verifying, by the reset module, the abnormality of the system module based on the abnormal state verification request signal.

7. A microgrid gateway comprising:
a memory including a plurality of root nodes;
a database; and
a system module which temporarily stores data collected in a lower region of a root node selected from the plurality of root nodes in real time, converts the state of the root node to a state in which predetermined information is being input, converts the state of the root node from the state in which the information is being input to a state indicating information input completion when the data collection is completed, stores the data temporarily stored in the lower region of the retrieved root node in the database when the root node of which the state is in the information input completion state is retrieved from one or more root nodes in the memory, and converts the state of the retrieved root node from the state indicating the information input completion to a database processing completion state.

8. The microgrid gateway of claim 7, further comprising:
a reset module which receives an abnormal state verification request signal to confirm whether the abnormal state transmitted from the system module is present at a predetermined time interval while the data is temporarily stored and transmits a response signal to the received abnormal state verification request signal to the system module.

9. The microgrid gateway of claim 8, wherein the reset module collects an electrical signal generated by the system module, converts the collected electrical signal to a feature vector, determines the abnormality of the system module, confirms that the system module is operating in an abnormal state when it is determined that there is the abnormality in the system module as the determining result, and resets the whole system including the reset module.
